(19) United States
(12) Patent Application Publication
(10) Pub. No.: US 2026/0281301 A1
(43) Pub. Date: Sep. 17, 2026

(54) VIDEO ENCODING AND VIDEO DECODING

(71) Applicant: Tencent Technology (Shenzhen) Company Limited, Shenzhen (CN)

(72) Inventors: Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/670,888

(22) Filed: May 7, 2026

Related U.S. Application Data
(63) Continuation of application No. PCT/CN2024/131388, filed on Nov. 11, 2024.

(30) Foreign Application Priority Data
Dec. 9, 2023 (CN) 202311693365.2

(51) Int. Cl. H04N 19/103; H04N 19/176; H04N 19/186

(52) U.S. Cl. CPC H04N 19/103; H04N 19/176; H04N 19/186

(57) ABSTRACT

A predictive coding mode of a current block in a current video frame is acquired. When the predictive coding mode is intra prediction mode, an intra prediction is performed to obtain at least a reconstructed value of a first color component for a pixel in the current block according to one or more reconstructed pixels in the current video frame. A mapping relationship is fit for the first color component of the current block and a second color component of the current block according to a reference region of the current block, the reference region is selected according to two or more template regions for the current block. According to at least the reconstructed value of the first color component for the pixel in the current block and the mapping relationship, a predicted value of the second color component for the pixel in the current block is generated.

### RELATED APPLICATIONS

The present application is a continuation of International Application No. PCT/CN2024/131388, filed on Nov. 11, 2024, which claims priority to Chinese Patent Application No. 202311693365.2, filed on Dec. 9, 2023. The entire disclosures of the prior applications are hereby incorporated by reference.

### FIELD OF THE TECHNOLOGY

This disclosure relates to the technical field of audio and video, including video encoding and video decoding.

### BACKGROUND OF THE DISCLOSURE

To adapt to large-scale data transmission of audio and video data, original audio and video data usually needs to be coded at a data transmission end to form a compressed data bitstream. After the data bitstream is transmitted to a data reception end, it is decoded and restored to obtain predicted and reconstructed audio and video data. Some related audio and video coding/decoding solutions suffer from issues such as low coding/decoding efficiency and poor accuracy.

### SUMMARY

This disclosure provides a video coding method, a video decoding method, a video coding apparatus, a video decoding apparatus, a computer-readable medium, an electronic device, and a computer program product, to improve the coding efficiency and the coding accuracy.

Some aspects of the disclosure provide a video decoding method. In some examples, a predictive coding mode of a current block in a current video frame is acquired (e.g., from coded information in a bitstream). When the predictive coding mode is intra prediction mode, an intra prediction is performed to obtain at least a reconstructed value of a first color component for a pixel in the current block according to one or more reconstructed pixels in the current video frame. A mapping relationship is fit for the first color component of the current block and a second color component of the current block according to a reference region of the current block, the reference region is selected according to two or more template regions for the current block. According to at least the reconstructed value of the first color component for the pixel in the current block and the mapping relationship, a predicted value of the second color component for the pixel in the current block is generated.

Some aspects of the disclosure provide a video encoding method. In an example, a predictive coding mode of a current block in a current video frame is determined. When the predictive coding mode is intra prediction mode, an intra prediction is performed to obtain at least a reconstructed value of a first color component for a pixel in the current block according to one or more reconstructed pixels in the current video frame. A mapping relationship is fitted for the first color component of the current block and a second color component of the current block according to a reference region of the current block, the reference region is selected according to two or more template regions for the current block. According to at least the reconstructed value of the first color component for the pixel in the current block and the mapping relationship, a predicted value of the second color component for the pixel in the current block is generated. The current block is encoded into coded information in a bitstream based on the predicted value of the second color component for the pixel in the current block.

According to an aspect of embodiments of this disclosure, a video decoding method is provided, including: acquiring a predictive coding mode of a current block, the current block being a to-be-decoded image block in a current video frame; performing, when the predictive coding mode is intra prediction, intra prediction according to a reference block corresponding to the current block to obtain a reconstructed value of a first color component of the current block, the reference block being a decoded image block in the current video frame; fitting a mapping relationship between the first color component of the current block and a second color component of the current block according to a reference region corresponding to the current block, the reference region including a nearest-neighbor or next-nearest-neighbor decoded image region of the current block; and mapping the reconstructed value of the first color component of the current block according to the mapping relationship to obtain a predicted value of the second color component of the current block.

According to an aspect of the embodiments of this disclosure, a video coding method is provided, including: acquiring a predictive coding mode of a current block, the current block being a to-be-coded image block in a current video frame; performing, when the predictive coding mode is intra prediction, intra prediction according to a reference block corresponding to the current block to obtain a reconstructed value of a first color component of the current block, the reference block being a coded-and-reconstructed image block in the current video frame; fitting a mapping relationship between the first color component of the current block and a second color component of the current block according to a reference region corresponding to the current block, the reference region including a nearest-neighbor or next-nearest-neighbor coded-and-reconstructed image region of the current block; and mapping the reconstructed value of the first color component of the current block according to the mapping relationship to obtain a predicted value of the second color component of the current block.

According to an aspect of the embodiments of this disclosure, a video decoding apparatus is provided, including: a first acquisition module, configured to acquire a predictive coding mode of a current block, the current block being a to-be-decoded image block in a current video frame; a first prediction module, configured to perform, when the predictive coding mode is intra prediction, intra prediction according to a reference block corresponding to the current block to obtain a reconstructed value of a first color component of the current block, the reference block being a decoded image block in the current video frame; a first fitting module, configured to fit a mapping relationship between the first color component of the current block and a second color component of the current block according to a reference region corresponding to the current block, the reference region including a nearest-neighbor or next-nearest-neighbor decoded image region of the current block; and a first mapping module, configured to map the reconstructed value of the first color component of the current block according to the mapping relationship to obtain a predicted value of the second color component of the current block.

According to an aspect of the embodiments of this disclosure, a video coding apparatus is provided, including: a second acquisition module, configured to acquire a predictive coding mode of a current block, the current block being a to-be-coded image block in a current video frame; a second prediction module, configured to perform, when the predictive coding mode is intra prediction, intra prediction according to a reference block corresponding to the current block to obtain a reconstructed value of a first color component of the current block, the reference block being a coded-and-reconstructed image block in the current video frame; a second fitting module, configured to fit a mapping relationship between the first color component of the current block and a second color component of the current block according to a reference region corresponding to the current block, the reference region including a nearest-neighbor or next-nearest-neighbor coded-and-reconstructed image region of the current block; and a second mapping module, configured to map the reconstructed value of the first color component of the current block according to the mapping relationship to obtain a predicted value of the second color component of the current block.

According to an aspect of the embodiments of this disclosure, a computer-readable medium (e.g., non-transitory computer-readable storage medium) is provided, having a computer program stored therein. The computer program, when executed by a processor, implements the video coding method and the video decoding method in the foregoing technical solutions.

According to an aspect of the embodiments of this disclosure, an electronic device is provided, including: a processor (an example of processing circuitry); and a memory, configured to store executable instructions of the processor. The processor is configured to execute the executable instructions to implement the video coding method and the video decoding method in the foregoing technical solutions.

According to an aspect of the embodiments of this disclosure, a computer program product is provided, including a computer program. The computer program, when executed by a processor, implements the video coding method and the video decoding method in the foregoing technical solutions.

In the technical solutions provided in the embodiments of this disclosure, when predictive coding is performed on the current block using intra prediction, intra prediction may be performed according to the reference block corresponding to the current block to obtain the reconstructed value of the first color component of the current block. The mapping relationship between the first color component and the second color component is fitted according to the reference region corresponding to the current block. Further, the reconstructed value of the first color component of the current block is mapped according to the mapping relationship to obtain the predicted value of the second color component of the current block. In the embodiments of this disclosure, intra prediction for the second color component is replaced with a color component mapping prediction mode, thereby improving the coding efficiency and accuracy of color component predictive coding.

### BRIEF DESCRIPTION OF THE DRAWINGS

FIG. 1 is a schematic diagram of an exemplary system architecture to which technical solutions in embodiments of this disclosure may be applied.

FIG. 2 schematically shows arrangement modes of a video coding apparatus and a video decoding apparatus in a streaming environment.

FIG. 3 is a schematic diagram of a basic procedure of a video coder, where in this procedure, intra prediction is used as an example for description.

FIG. 4 is a flowchart of operations of a video decoding method according to an embodiment of this disclosure.

FIG. 5 is a schematic diagram of a process of performing color component sampling on a current block according to an embodiment of this disclosure.

FIG. 6 is a flowchart of fitting a mapping relationship between color components according to an embodiment of this disclosure.

FIG. 7 is a schematic diagram of relationships between a specified pixel and neighboring pixels according to an embodiment of this disclosure.

FIG. 8 is a schematic diagram of a distribution of a reference region corresponding to a current block according to an embodiment of this disclosure.

FIG. 9 is a schematic diagram of a region template in which some sub-regions form a reference region according to an embodiment of this disclosure.

FIG. 10 is a schematic diagram of a region template of a reference region selected for a current block according to an embodiment of this disclosure.

FIG. 11 is a schematic diagram of selecting a sampling position based on position coordinates of a pixel according to an embodiment of this disclosure.

FIG. 12 is a schematic diagram of selecting a sampling position based on a bidirectional scanning mode according to an embodiment of this disclosure.

FIG. 13 is a schematic diagram of selecting a sampling position based on a ZigZag scanning mode according to an embodiment of this disclosure.

FIG. 14 is a schematic diagram of a sampling window for downsampling a first color component according to an embodiment of this disclosure.

FIG. 15 is a flowchart of operations of a video coding method according to an embodiment of this disclosure.

FIG. 16 is a schematic structural block diagram of a video decoding apparatus according to an embodiment of this disclosure.

FIG. 17 is a schematic structural block diagram of a video coding apparatus according to an embodiment of this disclosure.

FIG. 18 is a schematic structural block diagram of a computer system of an electronic device adapted to implementing an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Video coding usually refers to processing a picture sequence that forms a video or a video sequence. In the field of video coding, terms “picture”, “frame”, or “image” may be used as synonyms. Video coding used in the embodiments of this disclosure represents video encoding or video decoding. Video coding is performed at a source side, and usually includes processing (for example, by compressing) an original video picture to reduce a data volume required for representing the video picture, thereby enabling more efficient storage and/or transmission. Video decoding is performed at a destination side, and usually includes performing inverse processing relative to a coder to reconstruct a video picture. “Coding” of a video frame in the embodiments is to be understood as “coding” or “decoding” of a video image sequence. A combination of a coding part and a decoding part is alternatively referred to as coding/decoding (coding and decoding).

Each picture in the video image sequence is usually segmented into a set of non-overlapping blocks and coded at a block level. In other words, the coder usually processes, that is, codes, a video at a block (alternatively referred to as an image block or a video block) level. For example, a prediction block is generated through space (intra-picture) prediction and time (inter-picture) prediction. The prediction block is subtracted from a current block (a currently processed or to-be-processed block) to acquire a residual block. The residual block is transformed in a transform domain and quantized to reduce a to-be-transmitted (compressed) data volume. However, a decoder applies the inverse processing part relative to the coder to a coded or compressed block to reconstruct the current block for representation. In addition, the coder copies the decoder's processing loop, so that the coder and the decoder generate identical predictions (for example, intra prediction and inter prediction) and/or reconstructions for processing, that is, coding, subsequent blocks.

The term “block” can refer to a part of a picture or a frame. In the embodiments of this disclosure, the current block refers to a block currently being processed. For example, during coding, it refers to a block currently being coded. During decoding, it refers to a block currently being decoded.

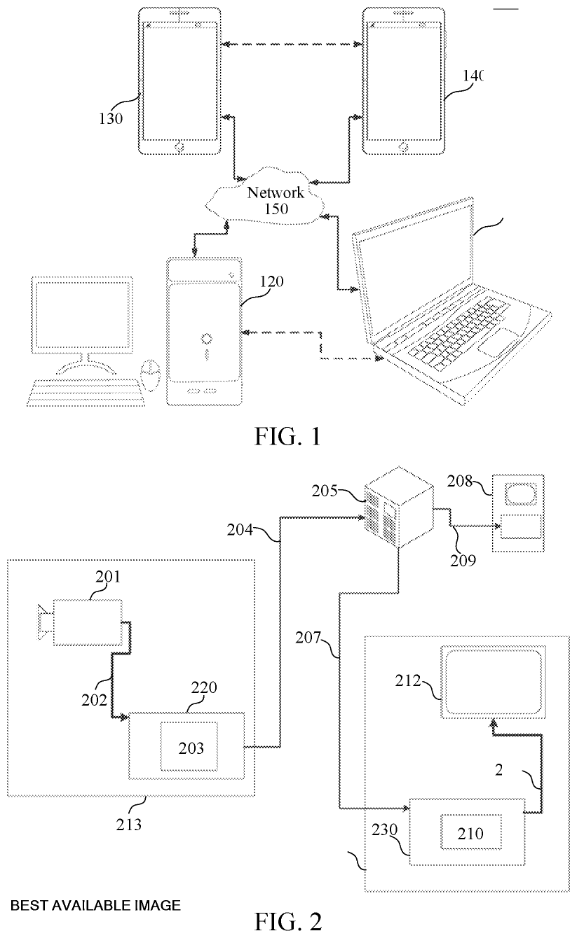

FIG. 1 is a schematic diagram of an exemplary system architecture to which technical solutions in embodiments of this disclosure may be applied.

As shown in FIG. 1, a system architecture 100 includes a plurality of terminal apparatuses. The terminal apparatuses may communicate with each other through, for example, a network 150. For example, the system architecture 100 may include a first terminal apparatus 110 and a second terminal apparatus 120 that are connected to each other through the network 150. In the embodiment of FIG. 1, the first terminal apparatus 110 and the second terminal apparatus 120 perform unidirectional data transmission.

For example, the first terminal apparatus 110 may code video data (for example, a video picture stream collected by the terminal apparatus 110) for transmission to the second terminal apparatus 120 through the network 150. Coded video data is transmitted in the form of one or more coded video bitstreams. The second terminal apparatus 120 may receive the coded video data from the network 150, decode the coded video data to restore the video data, and display a video picture according to the restored video data.

In an embodiment of this disclosure, the system architecture 100 may include a third terminal apparatus 130 and a fourth terminal apparatus 140 that perform bidirectional transmission of the coded video data. The bidirectional transmission may occur, for example, during a video conference. For bidirectional data transmission, one of the third terminal apparatus 130 and the fourth terminal apparatus 140 may code video data (for example, a video picture stream collected by the terminal apparatus) for transmission to the other of the third terminal apparatus 130 and the fourth terminal apparatus 140 through the network 150. One of the third terminal apparatus 130 and the fourth terminal apparatus 140 may further receive coded video data transmitted by the other of the third terminal apparatus 130 and the fourth terminal apparatus 140, decode the coded video data to restore the video data, and display a video picture on an accessible display apparatus according to the restored video data.

In the embodiment of FIG. 1, the first terminal apparatus 110, the second terminal apparatus 120, the third terminal apparatus 130, and the fourth terminal apparatus 140 may each be a server, a personal computer, and a smartphone, but the principles disclosed in this disclosure may not be limited thereto. The embodiment disclosed in this disclosure is adapted to a laptop computer, a tablet computer, a media player, and/or a dedicated video conference device. The network 150 represents any number of networks that transmit the coded video data among the first terminal apparatus 110, the second terminal apparatus 120, the third terminal apparatus 130, and the fourth terminal apparatus 140, and include, for example, wired and/or wireless communication networks. The communication network 150 may exchange data in a circuit-switched and/or packet-switched channel. The network may include a telecommunication network, a local area network, a wide area network, and/or the Internet. For the purpose of this disclosure, unless explained below, an architecture and a topology of the network 150 may be inconsequential to operations disclosed in this disclosure.

In an embodiment of this disclosure, FIG. 2 schematically shows arrangement modes of a video coding apparatus and a video decoding apparatus in a streaming environment. The subject disclosed in this disclosure may be equally applicable to other video-enabled applications, including, for example, video conferencing, a digital television (TV), and storing of compressed videos on digital media including a compact disc (CD), a digital video disc (DVD), a memory stick, and the like.

A streaming system may include a collection subsystem 213. The collection subsystem 213 may include a video source 201 such as a digital camera. The video source creates a video picture stream 202 that is uncompressed. In this embodiment, the video picture stream 202 includes samples photographed by the digital camera. Compared with coded video data 204 (or a coded video bitstream 204), the video picture stream 202 is depicted as a bold line to emphasize a video picture stream with a high data volume. The video picture stream 202 may be processed by an electronic apparatus 220. The electronic apparatus 220 includes a video coding apparatus 203 coupled to the video source 201. The video coding apparatus 203 may include hardware, software, or a combination of software and hardware, to implement or carry out aspects of the disclosed subject described below in more details. Compared with the video picture stream 202, the coded video data 204 (or the coded video bitstream 204) is depicted as a thin line to emphasize the coded video data 204 (or the coded video bitstream 204) with a low data volume, which may be stored on a streaming server 205 for future use. One or more streaming client subsystems, for example, a client subsystem 206 and a client subsystem 208 in FIG. 2, may access the streaming server 205 to retrieve a copy 207 and a copy 209 of the coded video data 204. The client subsystem 206 may include, for example, a video decoding apparatus 210 in an electronic apparatus 230. The video decoding apparatus 210 decodes the incoming copy 207 of the coded video data and generates an output video picture stream 211 that may be presented on a display 212 (for example, a display screen) or another presentation apparatus. In some streaming systems, the coded video data 204, video data 207, and video data 209 (for example, the video bitstream) may be coded according to some video coding/compression standards.

The electronic apparatus 220 and the electronic apparatus 230 may include other assemblies not shown. For example, the electronic apparatus 220 may include a video decoding apparatus, and the electronic apparatus 230 may further include a video coding apparatus.

In an embodiment of this disclosure, international video coding standards such as high efficiency video coding (HEVC, H.265) and versatile video coding (VVC, H.266) and the Chinese national video coding standard such as an audio video coding standard (AVS) are used as examples. After a video frame image is inputted, the video frame image is divided into several non-overlapping processing units according to a block size, and a similar compression operation is performed on each processing unit. The processing unit is referred to as a coding tree unit (CTU) or a largest coding unit (LCU). The CTU may be further divided into one or more basic coding units (CUs). The CU is the most basic element in a coding process.

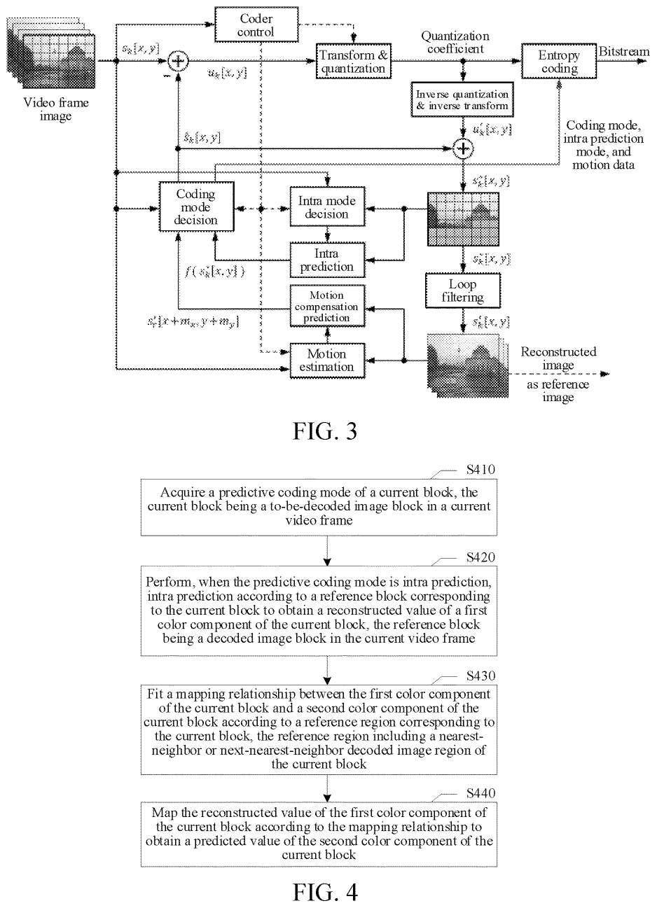

FIG. 3 is a schematic diagram of a basic procedure of a video coder, where in this procedure, intra prediction is used as an example for description.

A difference operation is performed on an original image signal sₖ[x, y] and a predicted image signal ŝₖ[x, y] to obtain a residual signal uₖ[x, y]. The residual signal uₖ[x, y] is transformed and quantized to obtain a quantization coefficient. Entropy coding is performed on the quantization coefficient to obtain a coded bitstream. In addition, inverse quantization and inverse transform are performed to obtain a reconstructed residual signal u′ₖ[x, y]. The predicted image signal ŝₖ[x, y] and the reconstructed residual signal u′ₖ[x, y] are superimposed to generate an image signal

$${s}_{k}^{*} [ x , y ] .$$

The image signal

$${s}_{k}^{*} [ x , y ]$$

is inputted to an intra mode decision module and an intra prediction module for intra prediction. In addition, a reconstructed image signal s′ₖ[x, y] is outputted through loop filtering. The reconstructed image signal s′ₖ[x, y] may be used as a reference image of a next frame for motion estimation and motion compensation prediction. Then, a predicted image signal ŝₖ[x, y] of the next frame is obtained based on a motion compensation prediction result s′ᵣ[x+mₓ, y+m_{y}] and an intra prediction result

$$f ( {s}_{k}^{*} [ x , y ] ) .$$

The foregoing process is repeated until the coding is completed.

A coding operation for each CU involved in the foregoing video coding process is described in detail below.

Predictive coding: the predictive coding includes modes such as intra prediction and inter prediction. After an original video signal is predicted by a selected reconstructed video signal, a residual video signal is obtained. A coder side needs to determine a predictive coding mode to be selected for a current CU, and inform a decoder side. Intra prediction means that a predicted signal comes from a coded-and-reconstructed region in the same image. Inter prediction means that the predicted signal comes from another coded image (referred to as a reference picture) different from a current image.

Transform and quantization: after transform operations such as discrete Fourier transform (DFT) and discrete cosine transform (DCT) are performed on the residual video signal, the signal is converted into a transform domain, which is referred to as a transform coefficient. A lossy quantization operation is further performed on the transform coefficient, and some information is lost so that the quantized signal facilitates compressed expression. In some video coding standards, more than one transform mode may be selected. Therefore, the coder side also needs to select one of the transform modes for the current CU and inform the decoder side. Quantization fineness is usually determined by a quantization parameter (QP). A larger value of the QP indicates that coefficients within a larger value range are quantized to the same output. Therefore, greater distortion and a lower bit rate are usually caused. On the contrary, a smaller value of the QP indicates that coefficients within a smaller value range are quantized to the same output. Therefore, less distortion and a higher bit rate are usually caused.

Entropy coding or statistical coding: statistical compression coding is performed on a quantized transform domain signal according to a frequency of occurrence of each value, and finally a binarized (0 or 1) compressed bitstream is outputted. Meanwhile, entropy coding also needs to be performed on other information generated through coding, for example, a selected coding mode and motion vector data, to reduce the bit rate. Statistical coding is a lossless coding mode that may effectively reduce a bit rate required to express the same signal. A statistical coding mode includes variable length coding (VLC) or context adaptive binary arithmetic coding (CABAC).

A CABAC process mainly includes three operations: binarization, context modeling, and binary arithmetic coding. After binarization is performed on an inputted syntax element, binary data may be coded in a common coding mode and a bypass coding mode. The bypass coding mode does not need to assign a specific probability model to each binary bit, and an inputted binary bit bin value is directly coded using a simple bypass coder to accelerate the entire coding and decoding process. In general, different syntax elements are not completely independent, and the same syntax elements have memory properties. Therefore, according to a conditional entropy theory, using other coded syntax elements for conditional coding can further improve the coding performance compared with independent coding or memoryless coding. Such coded symbolic information that is used as a condition is referred to as a context. In the common coding mode, binary bits of a syntax element sequentially enter a context modeler. The coder assigns an appropriate probability model for each inputted binary bit according to a value of a previously coded syntax element or binary bit. This process is referred to as context modeling. A context model corresponding to the syntax element may be located through a context index increment (ctxIdxInc) and a context index start (ctxIdxStart). After the bin value and the assigned probability model are transmitted together into a binary arithmetic coder for coding, the context model needs to be updated according to the bin value. This is an adaptive process in the coding.

Loop filtering: operations such as inverse quantization, inverse transform, and predictive compensation are performed on a transformed and quantized signal to obtain a reconstructed image. The reconstructed image has some information different from that in an original image as a result of quantization, that is, distortion may occur in the reconstructed image. Therefore, a filtering operation may be performed on the reconstructed image. For example, filters such as a deblocking filter (DB), a sample adaptive offset (SAO) filter, or an adaptive loop filter (ALF) are used so that a degree of distortion caused by quantization may be effectively reduced. Since the filtered reconstructed images will be used as a reference for subsequent coded images to predict future image signals, the foregoing filtering operation is alternatively referred to as loop filtering, i.e., a filtering operation in a coding loop.

Based on the foregoing coding process, on the decoder side, after a compressed bitstream (that is, a bitstream) is acquired for each CU, entropy decoding is performed to obtain various mode information and quantization coefficients. Then, inverse quantization and inverse transform are performed on the quantization coefficient to obtain a residual signal. In addition, a prediction signal corresponding to the CU may be obtained according to known coding mode information. Then, the residual signal and the prediction signal are added to obtain a reconstructed signal, and operations such as loop filtering are performed on the reconstructed signal to generate a final output signal.

The technical solutions such as a video coding method, a video decoding method, a video coding apparatus, a video decoding apparatus, a computer-readable medium, an electronic device, and a computer program product provided in this disclosure are described in detail below with reference to specific implementations.

FIG. 4 is a flowchart of operations of a video decoding method according to an embodiment of this disclosure. The video decoding method may be performed by a terminal device or a server that receives coded data. This embodiment of this disclosure is described using a video decoding method performed by a terminal device as an example. The terminal device may be, for example, the video decoding apparatus 210 shown in FIG. 2.

As shown in FIG. 4, the video decoding method in this embodiment of this disclosure includes the following operation S410 to operation S440.

S410: Acquire a predictive coding mode of a current block, the current block being a to-be-decoded image block in a current video frame.

S420: Perform, when the predictive coding mode is intra prediction, intra prediction according to a reference block corresponding to the current block to obtain a reconstructed value of a first color component of the current block, the reference block being a decoded image block in the current video frame.

S430: Fit a mapping relationship between the first color component and a second color component according to a reference region corresponding to the current block, the reference region including a nearest-neighbor or next-nearest-neighbor decoded image region of the current block.

S440: Map the reconstructed value of the first color component of the current block according to the mapping relationship to obtain a predicted value of the second color component of the current block.

In the technical solutions provided in the embodiments of this disclosure, when predictive coding is performed on the current block using intra prediction, intra prediction may be performed according to the reference block corresponding to the current block to obtain the reconstructed value of the first color component of the current block. The mapping relationship between the first color component and the second color component is fitted according to the reference region corresponding to the current block. Further, the reconstructed value of the first color component of the current block is mapped according to the mapping relationship to obtain the predicted value of the second color component of the current block.

An ordinary intra prediction mode refers to generating a current predicted image based on adjacent pixels along an assumed direction using a manually designed filter. Only a small quantity of adjacent reconstructed pixels is used. The components are independently predicted, and it is difficult for the manually designed filter to handle complex and diversified image texture features. Therefore, the prediction precision is not high. In the embodiments of this disclosure, ordinary intra prediction for the second color component is replaced with a color component mapping prediction mode, thereby improving the coding efficiency and accuracy of color component predictive coding.

The fitting involved in this disclosure refers to establishing a mathematical model or function by analyzing color components of the current block and the at least one image region in the reference region. The model can describe the mapping relationship between the first color component of the current block and the second color component of the current block. Therefore, the reconstructed value of the first color component of the current block may be mapped through the mapping relationship to predict the second color component of the current block.

Hereinafter, the method operations in the embodiments of this disclosure will be described in detail with reference to the specific implementations.

In operation S410, the predictive coding mode of the current block is acquired. The current block is a to-be-decoded image block in the current video frame.

A plurality of image regions may be obtained by segmenting the current video frame, and each image region or a combination of a plurality of image regions may be considered as an image block. The current block is a to-be-decoded image block in the current video frame.

In an embodiment of this disclosure, a luminance block and a chrominance block may be formed by performing color component sampling on the current block in a color space.

In addition to a luminance component (Y), an image in a color video further contains chrominance components (U, V), and such an image may alternatively be referred to as a YUV image. When the YUV image is coded, in addition to coding the luminance component, the chrominance component further needs to be coded. Since the human eye is more sensitive to luminance than to chrominance, during coding, to save storage space and improve coding efficiency, the luminance component is sampled at full resolution, and the chrominance component does not need to be sampled at full resolution. According to different methods for sampling the luminance component and the chrominance component in the color video, images of a video sequence usually include a YUV image in a 4:4:4 format, a YUV image in a 4:2:2 format, a YUV image in a 4:2:0 format, and the like.

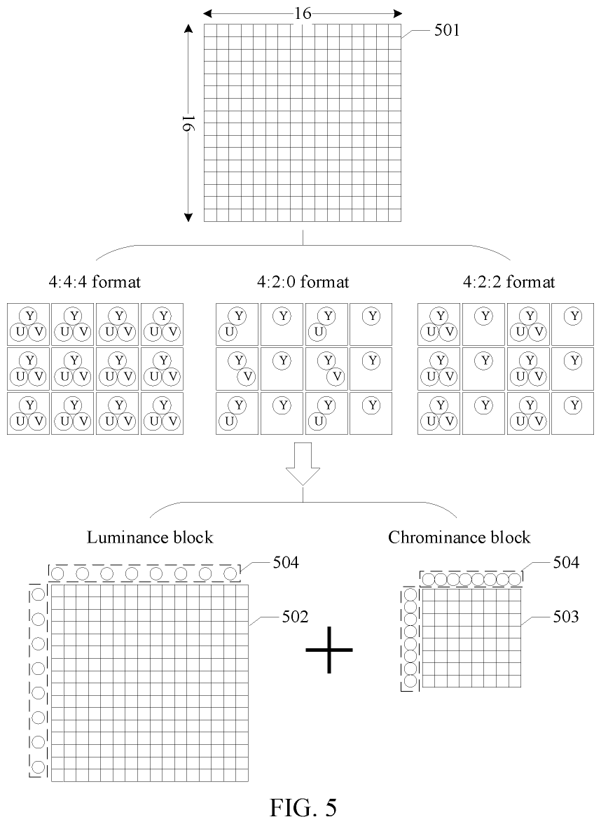

FIG. 5 is a schematic diagram of a process of performing color component sampling on a current block according to an embodiment of this disclosure. As shown in FIG. 5, a current block 501 is an image block with a size of 16×16. When color component sampling is performed on the current block 501, different resolution formats may be selected for sampling.

The 4:4:4 format indicates that there is no downsampling for the chrominance component. The 4:4:4 format is a format having the highest resolution for the chrominance component. When the 4:4:4 format is adopted for sampling, one Y component corresponds to a group of UV components, and data in four adjacent pixels includes four Y, four U, and four V.

The 4:2:2 format indicates that 2:1 horizontal downsampling is performed on the chrominance component relative to the luminance component, and there is no vertical downsampling. For every two U sampling points or V sampling points, each row contains four Y sampling points. When the 4:2:2 format is adopted for sampling, every two Y components share a group of UV components, and data in four adjacent pixels includes four Y, two U, and two V.

The 4:2:0 format indicates that 2:1 horizontal downsampling and 2:1 vertical downsampling are performed on the chrominance component relative to the luminance component. The 4:2:0 format is a format having the lowest resolution for the chrominance component, and is also the most common format. In the 4:2:0 format, chroma sampling is half of the luminance sampling in each row (i.e., the horizontal direction) and half of the luminance sampling in each column (i.e., the vertical direction). When the 4:2:0 format is adopted for sampling, the U component and the Y component appear alternately. For example, if YUV components appear in a first row at a ratio of 4:2:0, the three components appear in a second row at a ratio of 4:0:2. There are four Y, one U, and one V in four adjacent pixels.

When a video image adopts the 4:2:0 format, if a luminance component of an image block is an image block with a size of 2M×2N, a chrominance component of the image block is an image block with a size of M×N. For example, if the resolution of the image block is 720*480, the resolution of the luminance component of the image block is 720*480, and the resolution of the chrominance component of the image block is 360*240.

In this embodiment of this disclosure, the 4:2:0 format is used as an example. After a current CU 501 is sampled, a luminance block 502 and a chrominance block 503 may be obtained. The luminance block 502 is a 16×16 image block, and the corresponding chrominance block 503 is an 8×8 image block.

The predictive coding mode of the current block may include inter prediction, intra prediction, or another prediction mode. In video coding, main redundant information is temporal redundancy, followed by spatial redundancy. In video coding, the temporal redundancy is eliminated through inter prediction, and the spatial redundancy is eliminated through intra prediction.

In operation S420, when the predictive coding mode is intra prediction, intra prediction is performed according to the reference block corresponding to the current block to obtain the reconstructed value of the first color component of the current block. The reference block is a decoded image block in the current video frame.

Intra prediction refers to performing prediction using a reconstructed value of an adjacent block. In this process, preset weighting is performed on a coded adjacent pixel to obtain a good estimation of a current pixel block. There are two specific methods for intra prediction: one-dimensional prediction and two-dimensional prediction. The one-dimensional prediction refers to performing prediction using a correlation between adjacent pixels in the same row. Generally, a value of a next pixel is always close to a value of a previous pixel. In this way, the value of the previous pixel may be used as a predicted value of a current pixel. In the two-dimensional prediction, in addition to using adjacent pixels of a current row for prediction, a pixel of a previous row is further used for prediction. Corresponding weighted values are assigned to pixel values of different rows, to finally obtain predicted values.

The first color component being a luminance component Y is used as an example. Still referring to FIG. 5, after other image blocks adjacent to the current block 501 are coded and sampled, reference blocks located at an upper side and a left side of the current block may be obtained. Intra prediction may be performed on a corresponding luminance block 502 according to a reference pixel 504 in the reference block to obtain a reconstructed value of the luminance component.

Using a luminance block with a size of 16×16 as an example, intra prediction may be performed on the luminance block using four different prediction modes.

A mode 0 (vertical) refers to performing vertical deduction using a reference pixel (H) located at the upper side. A mode 1 (horizontal) refers to performing horizontal deduction using a reference pixel (V) located at the left side. A mode 2 (DC) refers to performing deduction using an average value of the reference pixel (H) located at the upper side and the reference pixel (V) located at the left side. A mode 3 (plane) refers to performing deduction through a linear plane function according to the reference pixel (H) located at the upper side and the reference pixel (V) located at the left side.

After prediction effects of various prediction modes are compared, an intra prediction mode most suitable for the current block may be selected for pixel coding, to obtain the reconstructed value of the luminance component of each pixel in the luminance block.

In operation S430, the mapping relationship between the first color component and the second color component is fitted according to the reference region corresponding to the current block. The reference region includes a nearest-neighbor or next-nearest-neighbor decoded image region of the current block.

The second color component is another color component different from the first color component in the color space. For example, when the first color component is a luminance component Y, the second color component may be a chrominance component U or a chrominance component V.

A YUV color space is used as an example. In this embodiment of this disclosure, for the current block having the YUV image format, multiple mapping relationships shown below may be obtained by fitting among multiple color components.
(1) The chrominance component U is predicted according to the luminance component Y to obtain a mapping relationship U=f(Y).
(2) The chrominance component V is predicted according to the luminance component Y to obtain a mapping relationship V=f(Y).
(3) The chrominance component V is predicted according to the chrominance component U to obtain a mapping relationship V=f(U).
(4) The chrominance component V is predicted according to the luminance component Y and the chrominance component U to obtain a mapping relationship V=f(Y,U).
(5) The chrominance component U is predicted according to the luminance component Y and the chrominance component V to obtain a mapping relationship U=f(Y,V).

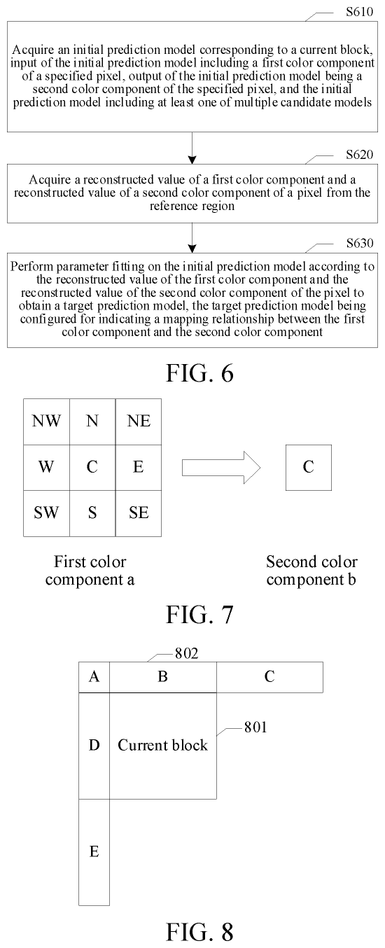

FIG. 6 is a flowchart of fitting a mapping relationship between color components according to an embodiment of this disclosure. As shown in FIG. 6, based on the foregoing embodiments, the determining a mapping relationship between the first color component and a second color component according to a reference region corresponding to the current block may further include the following operation S610 to operation S630.

S610: Acquire an initial prediction model corresponding to the current block, input of the initial prediction model including a first color component of a specified pixel, output of the initial prediction model being a second color component of the specified pixel, and the initial prediction model including at least one of multiple candidate models.

In an embodiment of this disclosure, the input of the initial prediction model further includes first color components of one or more neighboring pixels, and the neighboring pixel is a nearest-neighbor or next-nearest-neighbor pixel of the specified pixel.

FIG. 7 is a schematic diagram of relationships between a specified pixel and neighboring pixels according to an embodiment of this disclosure.

As shown in FIG. 7, C represents the specified pixel, and specified pixels in a first color component a and a second color component b may be pixel sample points at associated positions or at the same position.

The neighboring pixels of the specified pixel C may include a plurality of nearest-neighbor pixels, for example, a plurality of pixels N, S, W, and E that are located at the upper side, lower side, left side, and right side of the specified pixel C shown in FIG. 7.

The neighboring pixels of the specified pixel C may include a plurality of next-nearest-neighbor pixels, for example, a plurality of pixels NW, NE, SW, and SE that are located at the upper left, upper right, lower left, and lower right of the specified pixel C shown in FIG. 7.

Each such connection established between the first color component a and the second color component b may be referred to as a cross-component matching pair, and a mapping relationship equation may be generated. A plurality of such mapping relationship equations may solve weighting parameters of a model. An input position of the first color component a in the figure is merely an example, and a pixel sample point in a larger range may further be selected.

In an embodiment of this disclosure, the initial prediction model includes one or more combination items each having an independent weighting parameter, and the combination item uses first color components of at least two pixels as input.

The initial prediction model in this embodiment of this disclosure may include at least one monomial, and each monomial may have an independent weighting parameter. When a monomial has first color components of at least two pixels as the input, the monomial is referred to as a combination item.

In an embodiment of this disclosure, the initial prediction model may include at least two combination items with different orders, and the order is a highest power of the input in the combination item. A nonlinear factor may be introduced through an exponentiation operation to improve the fitting effect of the model for the mapping relationship between color components.

In an embodiment of this disclosure, the initial prediction model may be obtained by performing a weighted operation through one or more of the following monomials: x, mx±ny, xy, x^{k}, (mx±ny)^{k}, (mx±ny)(pz±qf), (mx±ny)x, and B,
where m, n, p, and q represent weighting coefficients for fixed weighting of the input; x, y, z, and f represent first color components of the specified pixel or the neighboring pixel; B represents a constant offset item; k represents an order of performing the exponentiation operation on the input, where k is an integer greater than 1.

In an embodiment of this disclosure, the initial prediction model may include one or more of the following candidate models.

$${C}_{b} = {p}_{0} C + {p}_{1} N + {p}_{2} S + {p}_{3} W + {p}_{4} E + {p}_{5} {C}^{2} + {p}_{6} B . \qquad ( 1 )$$

$${C}_{b} = {p}_{0} C + {p}_{1} N + {p}_{2} S + {p}_{3} W + {p}_{4} E + {p}_{5} B . \qquad ( 2 )$$

$${C}_{b} = {p}_{0} C + {p}_{1} B . \qquad ( 3 )$$

$${C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} {C}^{2} + {p}_{6} B . \qquad ( 4 )$$

$${C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} ( \frac{N + S}{2} ) ( \frac{W + E}{2} ) + {p}_{6} B . \qquad ( 5 )$$

$${C}_{b} = {p}_{0} C + {p}_{1} ( \frac{N + S}{2} ) + {p}_{2} ( \frac{W + E}{2} ) + {p}_{3} ( \frac{NW + SE}{2} ) + {p}_{4} ( \frac{NE + SW}{2} ) + {p}_{5} {C}^{2} + {p}_{6} B . \qquad ( 6 )$$

$${C}_{b} = {p}_{0} C + {p}_{1} ( \frac{N + S}{2} ) + {p}_{2} ( \frac{W + E}{2} ) + {p}_{3} ( \frac{NW + SE}{2} ) + {p}_{4} ( \frac{NE + SW}{2} ) + {p}_{5} ( \frac{N + S}{2} ) ( \frac{W + E}{2} ) + {p}_{6} B . \qquad ( 7 )$$

$${C}_{b} = {p}_{0} C + {p}_{1} ( \frac{N + S}{2} ) + {p}_{2} ( \frac{W + E}{2} ) + {p}_{3} ( \frac{NW + SE}{2} ) + {p}_{4} ( \frac{NE + SW}{2} ) + {p}_{5} B . \qquad ( 8 )$$

$${C}_{b} = {p}_{0} ( \frac{N + S + W + E}{4} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + W + E}{4} )}^{2} + {p}_{6} B . \qquad ( 9 )$$

$${C}_{b} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B . \qquad ( 10 )$$

$${C}_{b} = {p}_{0} C + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {p}_{5} {C}^{2} + {p}_{6} B . \qquad ( 11 )$$

$${C}_{b} = {p}_{0} C + {p}_{1} S + {p}_{2} W + {p}_{3} E + {p}_{4} SW + {p}_{5} SE + {p}_{6} {C}^{2} + {p}_{7} B . \qquad ( 12 )$$

S620. Acquire a reconstructed value of a first color component and a reconstructed value of a second color component of a pixel from the reference region corresponding to the current block.

In an embodiment of this disclosure, the reference region corresponding to the current block is formed by combining one or more nearest-neighbor regions or one or more next-nearest-neighbor regions. The nearest-neighbor region includes an image region that is located at an upper side or a left side of the current block and that has a specified image size, and the next-nearest-neighbor region includes an image region that is located at upper left, lower left, or upper right of the current block and that has a specified image size.

FIG. 8 is a schematic diagram of a distribution of a reference region corresponding to a current block according to an embodiment of this disclosure.

As shown in FIG. 8, a reference region corresponding to a current block 801 may include a plurality of sub-regions 802. Each sub-region 802 may be a nearest-neighbor region or a next-nearest-neighbor region of the current block. The nearest-neighbor region may include, for example, an image region B located at an upper side of the current block 801 or an image region D located at a left side of the current block 801. The next-nearest-neighbor region may include, for example, an image region A located at the upper left of the current block 801, an image region E located at the lower left of the current block 801, or an image region C located at the upper right of the current block 801.

The reference region of the current block 801 may be formed by combining one or more of the image region A-image region E.

In an embodiment of this disclosure, image sizes of the sub-regions forming the reference region are specified as follows.

A nearest-neighbor region B located at the upper side of the current block 801 has a same image size as the current block 801 in a horizontal direction and has the specified image size in a vertical direction.

A nearest-neighbor region D located at the left side of the current block 801 has the same image size as the current block 801 in the vertical direction and has the specified image size in the horizontal direction.

A next-nearest-neighbor region C located at the upper right of the current block 801 has the same image size as the current block 801 in the horizontal direction and has the specified image size in the vertical direction.

A next-nearest-neighbor region E located at the lower left of the current block 801 has the same image size as the current block 801 in the vertical direction and has the specified image size in the horizontal direction.

A next-nearest-neighbor region A located at the upper left of the current block 801 has the specified image size in both the horizontal direction and the vertical direction.

The specified image size may be a preset value greater than or equal to one. For example, the specified image size may be set to 6. When the specified image size is greater than one, color component prediction may be performed using a plurality of layers of neighboring pixels, thereby improving the accuracy of color component prediction.

In an embodiment of this disclosure, the sub-regions forming the reference region of the current block may have the same specified image size or different specified image sizes. For example, the size of the image region C in the vertical direction may be the same as or different from the size of the image region E in the horizontal direction.

In an embodiment of this disclosure, a pixel that has been decoded and reconstructed or that is allowed to be available may be selected from the sub-region as a reference pixel for color component prediction of the current block. For example, when some pixels in the image region C have been decoded and reconstructed, but other pixels in the image region C have not been decoded and reconstructed, the pixels that have been decoded and reconstructed may be selected from the image region C as reference pixels for color component prediction of the current block.

In an embodiment of this disclosure, when the decoded and reconstructed pixel in the sub-region does not satisfy the foregoing size specification, the next-nearest-neighbor region may be configured as unavailable. For example, when the lower right corner of the image region C is not reconstructed or extends beyond an image boundary, the image region C may be configured as unavailable. For another example, when the lower right corner of the image region E is not reconstructed or extends beyond the image boundary, the image region E may be configured as unavailable.

In an embodiment of this disclosure, all sub-regions shown in FIG. 8 may be combined to form the reference region of the current block, or some sub-regions may be combined to form the reference region of the current block.

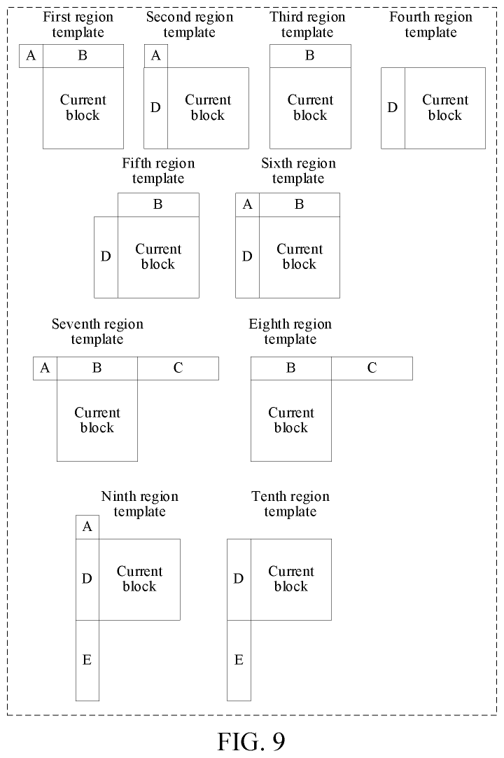

FIG. 9 is a schematic diagram of a region template in which some sub-regions form a reference region according to an embodiment of this disclosure. In some examples, the region template is referred to as the reference region. As shown in FIG. 9, ten exemplary candidate region templates may be formed based on different combinations of sub-regions. In this embodiment of this disclosure, one or more candidate region templates may be specified for the current block.

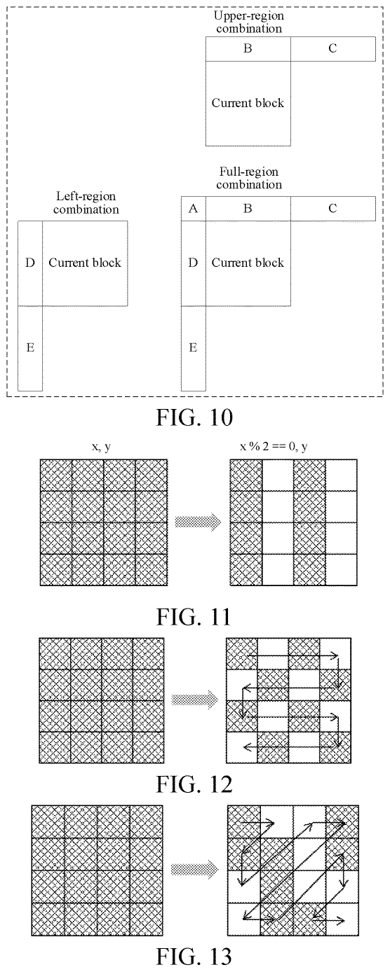

FIG. 10 is a schematic diagram of a region template of a reference region selected for a current block according to an embodiment of this disclosure. As shown in FIG. 10, in this embodiment of this disclosure, the reference region corresponding to the current block includes at least one of a full-region combination, a left-region combination, and an upper-region combination.

The full-region combination includes nearest-neighbor regions located at the left side and the upper side of the current block and next-nearest-neighbor regions located at the upper left, lower left, and upper right of the current block.

The left-region combination includes the nearest-neighbor region located at the left side of the current block and the next-nearest-neighbor region located at the lower left of the current block.

The upper-region combination includes the nearest-neighbor region located at the upper side of the current block and the next-nearest-neighbor region located at the upper right of the current block.

In an embodiment of this disclosure, an indication field may be used in the video bitstream to identify the region template of the reference region used by the current block. For example, when a value of the indication field is 1, the reference region selected for the current block is the full-region combination shown in FIG. 10. When the value of the indication field is 01, the reference region selected for the current block is the left-region combination shown in FIG. 10. When the value of the indication field is 00, the reference region selected for the current block is the upper-region combination shown in FIG. 10.

In an embodiment of this disclosure, after the reference region used during color component prediction of the current block is determined, availability information of one or more sub-regions forming the reference region may be acquired, and then a region range of the reference region is adjusted according to the availability information of the one or more sub-regions.

In an embodiment of this disclosure, adjusting the region range of the reference region according to the availability information of the one or more sub-regions may further include: removing a sub-region in an unavailable state from the reference region; and configuring, when all sub-regions in the reference region are in the unavailable state, the reference region to be in the unavailable state.

For example, the value of the indication field corresponding to the current block obtained by parsing the video bitstream is 1, indicating that the reference region used during color component prediction of the current block is the full-region combination including five sub-regions A to E shown in FIG. 10.

When the current block is coded and predicted, the availability information of the sub-regions in the reference region may be acquired, and the region range of the reference region may be adjusted according to the availability information.

For example, the sub-regions A, B, and C are image regions of other image blocks located at the upper side of the current block. If the image blocks where the sub-regions A, B, and C are located have not been coded and reconstructed, the sub-regions A, B, and C are in the unavailable state. In this case, the region range of the reference region may be adjusted from A+B+C+D+E to D+E.

For another example, the sub-regions D and E are image regions of other image blocks located at the left side of the current block. If the image blocks where the sub-regions D and E are located have not been coded and reconstructed, the sub-regions D and E are also in the unavailable state. In this case, the five sub-regions A to E are all in the unavailable state. Therefore, the entire reference region based on the full-region combination may be configured to be in the unavailable state.

S630: Perform parameter fitting on the initial prediction model according to the reconstructed value of the first color component and the reconstructed value of the second color component of the pixel to obtain a target prediction model, the target prediction model being configured for indicating the mapping relationship between the first color component and the second color component.

In an embodiment of this disclosure, the prediction model may fit model parameters through online training or offline training.

Online training refers to performing training and fitting in the coding/decoding process of the current video frame. The model parameters may be calculated online when each current block is coded/decoded.

Offline training refers to fitting and calculating the model parameters offline outside the coding/decoding process. In the offline training process, the model parameters are trained offline according to a pre-collected sample data set. Then, the trained target prediction model is directly used during coding/decoding, and the model parameters are no longer calculated in the coding/decoding process of the current video frame. Compared with the online training, the offline training exhibits reduced model prediction precision but a faster coding/decoding speed. Therefore, the offline training can be applicable to an application scene in which high coding/decoding quality is not required, but a fast coding/decoding speed is prioritized.

In an embodiment of this disclosure, in the training process of the prediction model, a plurality of sample pixels may be obtained by sampling in the reference region, and then parameter fitting is performed on the initial prediction model according to the reconstructed value of the first color component and the reconstructed value of the second color component of the sample pixel to obtain the target prediction model.

For example, in this embodiment of this disclosure, the reconstructed value of the first color component and the reconstructed value of the second color component of the sample pixel may be inputted to the initial prediction model to establish a plurality of equations, that is, Ax=b,

where A is a matrix having M rows and N columns, M and N represent a quantity of equations established according to the initial prediction model and a quantity of model parameters in the initial prediction model, respectively, and x represents a parameter vector formed using the model parameter in the initial prediction model as an element.

Solving the parameter vector x in the foregoing equation may obtain values of all model parameters pᵢ.

In an embodiment of this disclosure, an LDL decomposition method or a Gaussian elimination method may be selected to solve the foregoing equation. Using the LDL decomposition method as an example, the solving operations may include:
(1) transforming the equation into A^{T}Ax=A^{T}b;
(2) decomposing A^{T}A to obtain LDL^{T}x=A^{T}b;
(3) solving LY=A^{T}b to obtain a matrix Y; and
(4) solving DL^{T}x=Y to obtain a parameter vector x, so as to obtain the model parameter pᵢ.

In an embodiment of this disclosure, when the luminance component Y is selected as the first color component, and the chrominance component U and the chrominance component V are selected as the second color components, the chrominance component U and the chrominance component V are predicted according to the luminance component Y A^{T}A needs to be decomposed in the two prediction processes. In this case, the decomposition processes of A^{T}A in the two chrominance component prediction processes may be combined, thereby reducing the calculation complexity and improving the coding efficiency.

In an embodiment of this disclosure, the performing parameter fitting on the initial prediction model according to the reconstructed value of the first color component and the reconstructed value of the second color component of the pixel to obtain a target prediction model may further include: acquiring a reference region sampling mode of the current block, the reference region sampling mode including full-pixel sampling or partial-pixel sampling; determining, when the reference region sampling mode of the current block is full-pixel sampling, all pixels in the reference region corresponding to the current block as sample pixels; determining, when the reference region sampling mode of the current block is partial-pixel sampling, some pixels having specified sampling positions in the reference region corresponding to the current block as sample pixels; and performing parameter fitting on the initial prediction model according to a reconstructed value of a first color component and a reconstructed value of a second color component of the sample pixel to obtain the target prediction model.

In an embodiment of this disclosure, the specified sampling position includes at least one of the following three sampling positions.

A first sampling position is a specified sampling position at which position coordinates of the pixel satisfy a preset coordinate value condition.

In an embodiment of this disclosure, the coordinate value condition includes: at least one of a horizontal position coordinate and a vertical position coordinate of the pixel being an even number; or at least one of the horizontal position coordinate and the vertical position coordinate of the pixel being an odd number.

FIG. 11 is a schematic diagram of selecting a sampling position based on position coordinates of a pixel according to an embodiment of this disclosure.

As shown in FIG. 11, in the reference region, a coordinate system is established using the upper left corner as a coordinate origin (0, 0). A horizontal position coordinate x represents a sequential position of a pixel arranged from left to right in the horizontal direction, and a vertical position coordinate y represents a sequential position of a pixel arranged from top to bottom in the vertical direction.

According to the preset coordinate value condition, even positions, odd positions, or all positions may be selected as the specified sampling positions in the horizontal direction, or even positions, odd positions, or all positions may be selected as the specified sampling positions in the vertical direction.

For example, in the embodiment shown in FIG. 11, pixel positions at even positions in the horizontal direction and all positions in the vertical direction are selected as specified sampling positions. That is, pixel positions in a shadow part in the figure are selected as the specified sampling positions.

A second sampling position is a specified sampling position selected along a preset pixel scanning direction.

In an embodiment of this disclosure, pixels may be scanned in the reference region through any scanning mode such as bidirectional scanning or ZigZag scanning, so that specified sampling positions are selected along a preset pixel scanning direction according to an order and a preset sampling rule. The preset sampling rule may be, for example, interval sampling, that is, selecting one specified sampling position after skipping one or more scanned pixels.

FIG. 12 is a schematic diagram of selecting a sampling position based on a bidirectional scanning mode according to an embodiment of this disclosure.

As shown in FIG. 12, a row of pixels is scanned in the reference region in an order from left to right, and after a boundary is reached, a next row of pixels is scanned in an order from right to left. In the pixel scanning process, along the scanning direction, one specified sampling position is selected after skipping one scanned pixel. For example, an arrow shown in the figure indicates the scanning direction, and pixel positions in a shadow part are the selected specified sampling positions.

FIG. 13 is a schematic diagram of selecting a sampling position based on a ZigZag scanning mode according to an embodiment of this disclosure.

As shown in FIG. 13, pixels are scanned in the reference region from an upper left corner to a lower right corner according to the ZigZag scanning mode. In the pixel scanning process, along the scanning direction, one specified sampling position is selected after skipping one scanned pixel. For example, an arrow shown in the figure indicates the scanning direction, and pixel positions in a shadow part are the selected specified sampling positions.

A third sampling position is a specified sampling position at which the reconstructed value of the first color component falls within a preset value range.

The first color component being the luminance component is used as an example. In this embodiment of this disclosure, a position of a pixel whose luminance value is greater than or less than a threshold may be selected as the specified sampling position.

For example, one prediction model may be obtained through fitting by selecting sample pixels whose luminance values are greater than a set threshold in the reference region, and another prediction model may be obtained through fitting by selecting sample pixels whose luminance values are less than or equal to the set threshold. When the predicted image is generated, a corresponding first prediction model may be used for the pixels whose luminance values are greater than the set threshold, and a corresponding second prediction model may be used for the pixels whose luminance values are less than or equal to the set threshold.

In operation S440, the reconstructed value of the first color component of the current block is mapped according to the mapping relationship to obtain the predicted value of the second color component of the current block.

It can be learned based on the foregoing embodiment that, based on the target prediction model obtained through fitting, the reconstructed value of the first color component of the current block may be inputted to the target prediction model as the input, to obtain the predicted value of the second color component outputted by the target prediction model.

In an embodiment of this disclosure, color component prediction may be performed on some image blocks in the current video frame. Based on this, image blocks on which the color component prediction method for predicting the second color component according to the first color component is performed may be explicitly or implicitly identified.

In an embodiment of this disclosure, the mapping the reconstructed value of the first color component of the current block according to the mapping relationship to obtain a predicted value of the second color component of the current block may further include: acquiring a color component prediction condition of the current block, the color component prediction condition being configured for indicating whether to predict, according to one color component of the current block, another color component; and mapping, when the current block satisfies the color component prediction condition, the reconstructed value of the first color component of the current block according to the mapping relationship to obtain the predicted value of the second color component of the current block.

In an embodiment of this disclosure, the color component prediction condition includes at least one of the following conditions.

A first color component prediction condition is that an index corresponding to the current block has a specified index value.

For example, for a current block, an index may be decoded in a sequence header/image header/patch header/largest coding block. The index is configured for indicating whether the color component prediction method for predicting the second color component according to the first color component is performed on all image blocks in the current sequence/image/patch/largest coding block.

A second color component prediction condition is that image features of the current block satisfy a preset feature condition.

In an embodiment of this disclosure, the condition that image features of the current block satisfy a preset feature condition includes: the image size of the current block falling within a specified size range; or a position of the current block falling within a specified region range.

In an exemplary implementation, whether the color component prediction method for predicting the second color component according to the first color component is performed on the current block may be indicated according to whether the image size of the current block meets a preset range limit.

In an exemplary implementation, whether the color component prediction method for predicting the second color component according to the first color component is performed on the current block may be indicated according to whether the position of the current block meets a preset range limit. For example, if the current block is located at the upper left corner of the current video frame, the color component prediction method for predicting the second color component according to the first color component is not performed.

A third color component prediction condition is that image features of the reference region corresponding to the current block satisfy the preset feature condition.

In an embodiment of this disclosure, the condition that image features of the reference region corresponding to the current block satisfy the preset feature condition includes: a region area of the reference region corresponding to the current block being greater than a specified area threshold; or a quantity of specified sampling positions in the reference region corresponding to the current block being greater than a quantity of model parameters of a prediction model, the prediction model being configured for indicating the mapping relationship between the first color component and the second color component.

In an exemplary implementation, the color component prediction method for predicting the second color component according to the first color component is performed on the current block only when the region area of the reference region is greater than the specified area threshold.

In an exemplary implementation, the color component prediction method for predicting the second color component according to the first color component is performed on the current block only when the quantity of specified sampling positions in the reference region (that is, a quantity of matching pairs of the first color component and the second color component) is greater than the quantity of model parameters of the prediction model.

In an embodiment of this disclosure, before mapping the reconstructed value of the first color component of the current block according to the mapping relationship, the first color component may be downsampled to obtain a first color component that can form a matching pair with the second color component.

Using the YUV-format image block shown in FIG. 5 as an example, when the first color component is the luminance component Y, and the second color component is the chrominance component U or the chrominance component V, a luminance block and a chrominance block obtained after color component sampling is performed according to a 420 sampling format have different block sizes. In the horizontal direction and the vertical direction, the resolution of the luminance component is twice that of the chrominance component. In this case, to form a matching pair using the luminance component and the chrominance component, the luminance component may be downsampled.

In an embodiment of this disclosure, a method for downsampling the first color component may include: determining a sampling window having a specified window size according to a pixel position of the second color component of the current block; and downsampling the reconstructed value of the first color component of the current block in the sampling window to obtain a reconstructed value of a first color component matching the pixel position.

In an embodiment of this disclosure, the sampling window determined according to the pixel position of the second color component is configured for covering four nearest-neighbor first color components and two next-nearest-neighbor first color components located at the left side.

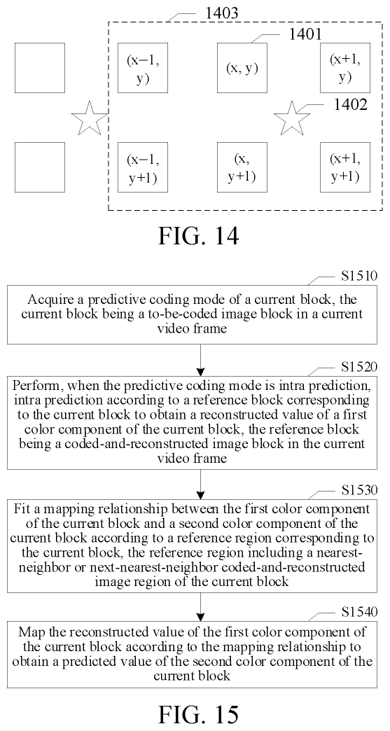

FIG. 14 is a schematic diagram of a sampling window for downsampling a first color component according to an embodiment of this disclosure.

As shown in FIG. 14, squares distributed in an array form represent first color components 1401, and a five-pointed star distributed in the array represents a second color component 1402. In this embodiment of this disclosure, a sampling window 1403 having a specified window size corresponding to the second color component 1402 may be determined according to a pixel position of the second color component 1402. For example, the sampling window 1403 in this embodiment of this disclosure can cover four nearest-neighbor first color components of the second color component and two next-nearest-neighbor first color components located at the left side.

In an embodiment of this disclosure, the downsampling the reconstructed value of the first color component of the current block in the sampling window to obtain a reconstructed value of a first color component matching the pixel position may further include: acquiring a position relationship between the reconstructed value of the first color component of the current block and the pixel position in the sampling window; and performing a weighted operation on the reconstructed value of the first color component according to the position relationship to obtain the reconstructed value of the first color component matching the pixel position.

For example, in this embodiment of this disclosure, the first color component may be downsampled according to the following formula:

$${L}^{′} ( x , y ) = ( L ( x - 1 , y ) + 2 L ( x , y ) + L ( x + 1 , y ) + L ( x - 1 , y + 1 ) + 2 L ( x , y + 1 ) + L ( x + 1 , y + 1 ) ) / 8 ,$$

where L and L′ represent an original first color component and a downsampled first color component, respectively.

x and y represent a horizontal position coordinate and a vertical position coordinate of the first color component, respectively. Using the sampling window shown in FIG. 14 as an example, two nearest-neighbor first color components located at the left side of the second color component, that is, (x, y) and (x, y+1), may each be assigned a weighting coefficient of ¼. The other four first color components, that is, (x−1, y), (x−1, y+1), (x+1, y), and (x+1, y+1), may each be assigned a weighting coefficient of ⅛.

In an embodiment of this disclosure, when two next-nearest-neighbor first color components located at the left side are unavailable, that is, when (x−1, y) or (x−1, y+1) is unavailable, the two nearest-neighbor first color components located at the left side may be used, that is, (x, y) or (x, y+1) is used.

In an embodiment of this disclosure, when the first color component of the current block is selected to be downsampled, the reconstructed value of the first color component used as a model training sample may be synchronously downsampled in the reference region corresponding to the current block. That is, before the mapping relationship between the first color component of the current block and the second color component of the current block is fitted according to the reference region corresponding to the current block, a sampling window having a specified window size is determined according to a pixel position of the second color component in the reference region. The reconstructed value of the first color component in the reference region is downsampled in the sampling window to obtain a reconstructed value of a first color component matching the pixel position.

In an embodiment of this disclosure, the first color component may be selected to be downsampled. Alternatively, the first color component having the same position as or corresponding to the second color component may be selected for color component prediction instead of downsampling. Using FIG. 14 as an example, the first color component 1401 that corresponds to the second color component 1402 and has position coordinates of (x, y) may be selected for color component prediction.

In an embodiment of this disclosure, when the sampling format of the first color component is the same as that of the second color component, before color component prediction is performed on the first color component through the prediction model, the first color component may be first filtered to reduce redundant information or interference information in the first color component, thereby further improving the prediction accuracy of the second color component, that is, improving the video coding accuracy of the current block.

Based on this, when the prediction model is fitted, a plurality of filters may be simultaneously selected to filter sample data of the first color component, so that different first color component samples may be selected to train and fit the prediction model, thereby improving the fitting and training effect of the prediction model.

In an embodiment of this disclosure, after the first color component is downsampled or filtered, boundary extension may be performed on the pixel position of the first color component according to needs, thereby obtaining a neighboring pixel for the specified pixel.

Multiple different color component prediction solutions are introduced in the foregoing embodiments. For example, the reference region includes multiple different candidate region templates, and the prediction model also includes multiple different candidate prediction models. Multiple different color component prediction solutions may be obtained by combining the multiple different candidate region templates with the multiple different candidate prediction models.

For different image blocks, the same color component prediction solution or different color component prediction solutions may be selected.

In an embodiment of this disclosure, for example, image blocks having different block sizes may use different color component prediction solutions (candidate region templates and candidate prediction models).

In an embodiment of this disclosure, the color component prediction solution used by the current block may be indicated in the data bitstream through an explicit index or an implicit index. For example, the candidate region template and/or the candidate prediction model used by the current block may be indicated through one index or a combination of a plurality of indexes.

In an embodiment of this disclosure, multiple different color component prediction solutions may be used for a current block, and then a weighted operation is performed on prediction results of the multiple solutions to obtain a final color component prediction result.

FIG. 15 is a flowchart of operations of a video coding method according to an embodiment of this disclosure. The video coding method may be performed by a terminal device or a server that transmits coded data. This embodiment of this disclosure is described using a video coding method performed by a terminal device as an example. The terminal device may be, for example, the video coding apparatus 203 shown in FIG. 2.

As shown in FIG. 15, the video coding method in this embodiment of this disclosure includes the following operation S1510 to operation S1540.

S1510: Acquire a predictive coding mode of a current block, the current block being a to-be-coded image block in a current video frame.

S1520: Perform, when the predictive coding mode is intra prediction, intra prediction according to a reference block corresponding to the current block to obtain a reconstructed value of a first color component of the current block, the reference block being a coded-and-reconstructed image block in the current video frame.

S1530: Fit a mapping relationship between the first color component and a second color component according to a reference region corresponding to the current block, the reference region including a nearest-neighbor or next-nearest-neighbor coded-and-reconstructed image region of the current block.

S1540: Map the reconstructed value of the first color component of the current block according to the mapping relationship to obtain a predicted value of the second color component of the current block.

Operations of the video coding method in this embodiment of this disclosure are in a one-to-one correspondence with those of the video decoding method in the foregoing embodiment, and details are not described herein again.

The following describes implementation processes in a plurality of application scenes using some embodiments of the technical solutions of this disclosure.

In a first application scene, for the intra prediction mode, the chrominance component U and the chrominance component V are separately predicted using the luminance component Y The adopted prediction model is as follows:

$${C}_{b} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B .$$

In the application scene, a plurality of candidate region templates of the reference region are used. For example, three templates such as the full-region combination, the left-region combination, and the upper-region combination shown in FIG. 10 may be selected. The reference region template actually used by the current block may be obtained by parsing the data bitstream.

Considering the availability of adjacent pixels, if an upper region or a left region of a current block is completely unavailable, the left-region combination template and the upper-region combination template are not allowed to be used, and the reference region template used by the current block may be directly determined as the full-region combination template.

First, the reconstructed value of the luminance component in the reference region is downsampled. For example, the sampling window shown in FIG. 14 may be used. The downsampling process is as follows:

$${L}^{′} ( x , y ) = ( L ( x - 1 , y ) + 2 L ( x , y ) + L ( x + 1 , y ) + L ( x - 1 , y + 1 ) + 2 L ( x , y + 1 ) + L ( x + 1 , y + 1 ) ) / 8.$$

After the reconstructed value of the luminance component is downsampled, a luminance component whose position coordinates are not odd in the horizontal direction and the vertical direction is selected from the reference region as the sample pixel to construct a matching pair of the reconstructed value of the luminance component and the reconstructed value of the chrominance component. In another exemplary implementation, a luminance component having at least one even position coordinate in the horizontal direction and the vertical direction may alternatively be selected from the reference region as the sample pixel.

The matching pair is inputted to the prediction model. The equation is established, and then the model parameters pᵢ in the prediction model are solved to obtain a first prediction model configured for predicting the chrominance component U according to the luminance component Y and a second prediction model configured for predicting the chrominance component V according to the luminance component Y.

After downsampling, the reconstructed value of the luminance component in the current block is inputted to the fitted and trained first prediction model and second prediction model to obtain prediction results of the chrominance component U and the chrominance component V.

In a second application scene, for the intra prediction mode, the chrominance component U and the chrominance component V are separately predicted using the luminance component Y The adopted prediction model is as follows:

$${C}_{b =} = {p}_{0} C + {p}_{1} S + {p}_{2} W + {p}_{3} E + {p}_{4} SW + {p}_{5} SE + {p}_{6} {C}^{2} + {p}_{7} B .$$

In the application scene, a plurality of candidate region templates of the reference region are used. For example, three templates such as the full-region combination, the left-region combination, and the upper-region combination shown in FIG. 10 may be selected. The reference region template actually used by the current block may be obtained by parsing the data bitstream.

Considering the availability of adjacent pixels, if an upper region or a left region of a current block is completely unavailable, the left-region combination template and the upper-region combination template are not allowed to be used, and the reference region template used by the current block may be directly determined as the full-region combination template.

In the application scene, the reconstructed value of the luminance component in the reference region is not downsampled, and model fitting is directly performed. That is, all luminance components in the reference region are used as sample pixels to construct matching pairs of the reconstructed values of the luminance components and the reconstructed values of the chrominance components.

The matching pair is inputted to the prediction model. The equation is established, and then the model parameters pᵢ in the prediction model are solved to obtain a first prediction model configured for predicting the chrominance component U according to the luminance component Y and a second prediction model configured for predicting the chrominance component V according to the luminance component Y.

The reconstructed value of the luminance component in the current block is inputted to the fitted and trained first prediction model and second prediction model to obtain prediction results of the chrominance component U and the chrominance component V.

It can be learned based on the foregoing embodiments and descriptions of application scenes that this embodiment of this disclosure proposes a multi-template-based color component prediction method. A plurality of reference region templates for constructing a color component prediction model are generated based on adjacent reconstructed pixel regions to obtain more color component prediction results. An optimal color component prediction result may be selected based on these different reference region templates, thereby improving the prediction precision of the color component prediction method for complex textures.

Although the operations of the method in this disclosure are described in a specific sequence in the accompanying drawings, this does not require or imply that these operations have to be performed according to the specific sequence, or all the operations shown have to be performed to achieve an expected result. Additionally or alternatively, some operations may be omitted, a plurality of operations may be combined into one operation for execution, and/or one operation may be decomposed into a plurality of operations for execution, and the like.

Apparatus embodiments of this disclosure are described below. The apparatus embodiments may be configured for performing the video coding and decoding methods in the foregoing embodiments of this disclosure.

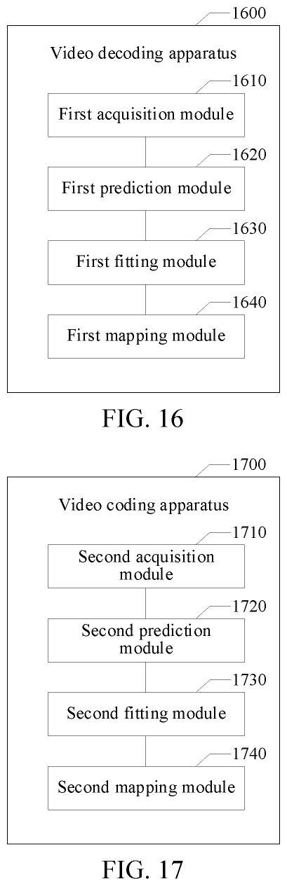

FIG. 16 is a schematic structural block diagram of a video decoding apparatus according to an embodiment of this disclosure. As shown in FIG. 16, a video decoding apparatus 1600 includes:
a first acquisition module 1610, configured to acquire a predictive coding mode of a current block, the current block being a to-be-decoded image block in a current video frame;
a first prediction module 1620, configured to perform, when the predictive coding mode is intra prediction, intra prediction according to a reference block corresponding to the current block to obtain a reconstructed value of a first color component of the current block, the reference block being a decoded image block in the current video frame;
a first fitting module 1630, configured to fit a mapping relationship between the first color component of the current block and a second color component of the current block according to a reference region corresponding to the current block, the reference region including a nearest-neighbor or next-nearest-neighbor decoded image region of the current block; and
a first mapping module 1640, configured to map the reconstructed value of the first color component of the current block according to the mapping relationship to obtain a predicted value of the second color component of the current block.

In an embodiment of this disclosure, based on the foregoing embodiments, the first fitting module 1630 may further include:
a model acquisition module, configured to acquire an initial prediction model corresponding to the current block, input of the initial prediction model including a first color component of a specified pixel, output of the initial prediction model being a second color component of the specified pixel, and the initial prediction model including at least one of multiple candidate models;
a reconstructed value acquisition module, configured to acquire a reconstructed value of a first color component and a reconstructed value of a second color component of a pixel from the reference region; and
a model fitting module, configured to perform parameter fitting on the initial prediction model according to the reconstructed value of the first color component and the reconstructed value of the second color component of the pixel to obtain a target prediction model, the target prediction model being configured for indicating the mapping relationship between the first color component and the second color component.

In an embodiment of this disclosure, based on the foregoing embodiments, the input of the initial prediction model further includes first color components of one or more neighboring pixels, and the neighboring pixel is a nearest-neighbor or next-nearest-neighbor pixel of the specified pixel.

In an embodiment of this disclosure, based on the foregoing embodiments, the initial prediction model includes one or more combination items each having an independent weighting parameter, and the combination item uses first color components of at least two pixels as input.

In an embodiment of this disclosure, based on the foregoing embodiments, the initial prediction model includes at least two combination items with different orders, and the order is a highest power of the input in the combination item.

In an embodiment of this disclosure, based on the foregoing embodiments, the reference region includes one or more nearest-neighbor regions or one or more next-nearest-neighbor regions. The nearest-neighbor region includes an image region that is located at an upper side or a left side of the current block and that has a specified image size, and the next-nearest-neighbor region includes an image region that is located at upper left, lower left, or upper right of the current block and that has a specified image size.

In an embodiment of this disclosure, based on the foregoing embodiments, a next-nearest-neighbor region located at the upper right of the current block has a same image size as the current block in a horizontal direction and has the specified image size in a vertical direction, and the specified image size is greater than or equal to one.

A next-nearest-neighbor region located at the lower left of the current block has the same image size as the current block in the vertical direction and has the specified image size in the horizontal direction.

A next-nearest-neighbor region located at the upper left of the current block has the specified image size in both the horizontal direction and the vertical direction.

In an embodiment of this disclosure, based on the foregoing embodiments, the reference region includes at least one of a full-region combination, a left-region combination, or an upper-region combination.

The full-region combination includes nearest-neighbor regions located at the left side and the upper side of the current block and next-nearest-neighbor regions located at the upper left, lower left, and upper right of the current block.

The left-region combination includes the nearest-neighbor region located at the left side of the current block and the next-nearest-neighbor region located at the lower left of the current block.

The upper-region combination includes the nearest-neighbor region located at the upper side of the current block and the next-nearest-neighbor region located at the upper right of the current block.

In an embodiment of this disclosure, based on the foregoing embodiments, the model fitting module may further include:
a sampling mode acquisition module, configured to acquire a reference region sampling mode of the current block, the reference region sampling mode including full-pixel sampling or partial-pixel sampling;
a full sampling module, configured to determine, when the reference region sampling mode of the current block is full-pixel sampling, all pixels in the reference region as sample pixels;
a partial sampling module, configured to determine, when the reference region sampling mode of the current block is partial-pixel sampling, some pixels having specified sampling positions in the reference region as sample pixels; and
a parameter fitting module, configured to perform parameter fitting on the initial prediction model according to a reconstructed value of a first color component and a reconstructed value of a second color component of the sample pixel to obtain the target prediction model.

In an embodiment of this disclosure, based on the foregoing embodiments, the specified sampling position includes at least one of the following sampling positions:
a specified sampling position at which position coordinates of the pixel satisfy a preset coordinate value condition;
a specified sampling position selected along a preset pixel scanning direction; and
a specified sampling position at which the reconstructed value of the first color component falls within a preset value range.

In an embodiment of this disclosure, based on the foregoing embodiments, the coordinate value condition includes:
at least one of a horizontal position coordinate or a vertical position coordinate of the pixel being even; or
at least one of the horizontal position coordinate or the vertical position coordinate of the pixel being odd.

In an embodiment of this disclosure, based on the foregoing embodiments, the first mapping module may further include:
a prediction condition acquisition module, configured to acquire a color component prediction condition of the current block, the color component prediction condition being configured for indicating whether to predict, according to one color component of the current block, another color component; and
a reconstructed value mapping module, configured to map, when the current block satisfies the color component prediction condition, the reconstructed value of the first color component of the current block according to the mapping relationship to obtain the predicted value of the second color component of the current block.

In an embodiment of this disclosure, based on the foregoing embodiments, the color component prediction condition includes at least one of the following conditions:
an index corresponding to the current block has a specified index value;
image features of the current block satisfy a preset feature condition; and
image features of the reference region satisfy the preset feature condition.

In an embodiment of this disclosure, based on the foregoing embodiments, the condition that image features of the current block satisfy a preset feature condition includes:
the image size of the current block falling within a specified size range; or
a position of the current block falling within a specified region range.

In an embodiment of this disclosure, based on the foregoing embodiments, the condition that image features of the reference region satisfy the preset feature condition includes:
a region area of the reference region being greater than a specified area threshold; or
a quantity of specified sampling positions in the reference region being greater than a quantity of model parameters of a prediction model, the prediction model being configured for indicating the mapping relationship between the first color component and the second color component.

In an embodiment of this disclosure, based on the foregoing embodiments, the video decoding apparatus 1600 may further include:
a current block downsampling module, configured to determine a sampling window having a specified window size according to a pixel position of the second color component of the current block; and downsample the reconstructed value of the first color component of the current block in the sampling window to obtain a reconstructed value of a first color component matching the pixel position.

In an embodiment of this disclosure, based on the foregoing embodiments, the current block downsampling module is further configured to: acquire a position relationship between the reconstructed value of the first color component of the current block and the pixel position in the sampling window; and perform a weighted operation on the reconstructed value of the first color component according to the position relationship to obtain the reconstructed value of the first color component matching the pixel position.

In an embodiment of this disclosure, based on the foregoing embodiments, the video decoding apparatus 1600 may further include:
a reference region downsampling module, configured to determine a sampling window having a specified window size according to a pixel position of the second color component in the reference region; and downsample the reconstructed value of the first color component in the reference region in the sampling window to obtain a reconstructed value of a first color component matching the pixel position.

FIG. 17 is a schematic structural block diagram of a video coding apparatus according to an embodiment of this disclosure. As shown in FIG. 17, a video coding apparatus 1700 includes:
a second acquisition module 1710, configured to acquire a predictive coding mode of a current block, the current block being a to-be-coded image block in a current video frame;
a second prediction module 1720, configured to perform, when the predictive coding mode is intra prediction, intra prediction according to a reference block corresponding to the current block to obtain a reconstructed value of a first color component of the current block, the reference block being a coded-and-reconstructed image block in the current video frame;
a second fitting module 1730, configured to fit a mapping relationship between the first color component of the current block and a second color component of the current block according to a reference region corresponding to the current block, the reference region including a nearest-neighbor or next-nearest-neighbor coded-and-reconstructed image region of the current block; and
a second mapping module 1740, configured to map the reconstructed value of the first color component of the current block according to the mapping relationship to obtain a predicted value of the second color component of the current block.

In this embodiment of this disclosure, specific implementations of the modules in the video coding apparatus 1700 have a correspondence with those of the modules in the video decoding apparatus 1600 and may refer to related descriptions in the foregoing embodiments. Details are not described herein again.

Specific details of the video decoding apparatus and the video coding apparatus provided in the embodiments of this disclosure have been described in detail in corresponding method embodiments, and details are not described herein again.

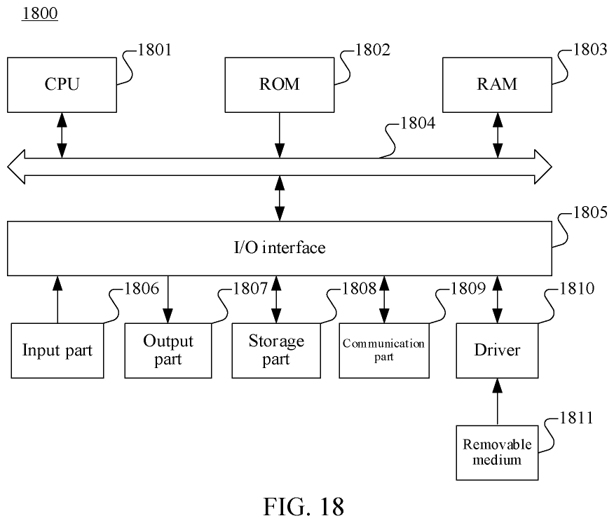

FIG. 18 is a schematic structural block diagram of a computer system of an electronic device configured to implement an embodiment of this disclosure.

A computer system 1800 of the electronic device shown in FIG. 18 is merely an example, and does not constitute any limitation on functions and use ranges of the embodiments of this disclosure.

As shown in FIG. 18, the computer system 1800 includes a central processing unit (CPU) 1801. The CPU 1801 may perform various appropriate actions and processing according to a program stored in a read-only memory (ROM) 1802 or a program loaded from a storage part 1808 into a random access memory (RAM) 1803. The RAM 1803 further stores various programs and data required by system operations. The CPU 1801, the ROM 1802, and the RAM 1803 are connected to each other through a bus 1804. An input/output (I/O) interface 1805 is further connected to the bus 1804.

The following components are connected to the I/O interface 1805: an input part 1806 including a keyboard, a mouse, or the like, an output part 1807 including a cathode ray tube (CRT), a liquid crystal display (LCD), a speaker, or the like, a storage part 1808 including a hard disk, or the like, and a communication part 1809 including a network interface card such as a local area network card or a modem. The communication part 1809 performs communication processing via a network such as the Internet. A driver 1810 is further connected to the I/O interface 1805 according to needs. A removable medium 1811, such as a magnetic disk, an optical disc, a magneto-optical disk, or a semiconductor memory, is installed on the driver 1810 according to needs so that a computer program read from the removable medium is installed into the storage part 1808 according to needs.

Particularly, according to the embodiments of this disclosure, the processes described in the various method flowcharts may be implemented as computer software programs. For example, the embodiments of this disclosure include a computer program product. The computer program product includes a computer program carried on a computer-readable medium, and the computer program contains program code for performing the methods shown in the flowcharts. In such embodiments, the computer program may be downloaded and installed from a network through the communication part 1809, and/or installed from the removable medium 1811. When the computer program is executed by the CPU 1801, various functions defined in the system of this disclosure are executed.

The flowcharts and block diagrams in the accompanying drawings illustrate system architectures, functions, and operations that may be implemented by the system, the method, and the computer program product according to various embodiments of this disclosure. In this regard, each box in a flowchart or a block diagram may represent a module, a program segment, or a part of code. The module, the program segment, or the part of code contains one or more executable instructions configured for implementing specified logic functions. In some implementations used as substitutes, functions annotated in boxes may alternatively occur in an order different from that annotated in the accompanying drawing. For example, actually two boxes shown in succession may be performed basically in parallel, and sometimes the two boxes may be performed in a reverse order. This is determined by a related function. Each box in a block diagram or a flowchart and a combination of boxes in the block diagram or the flowchart may be implemented using a dedicated hardware-based system configured to perform a specified function or operation, or may be implemented using a combination of dedicated hardware and a computer instruction.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A video decoding method, comprising:
acquiring a predictive coding mode of a current block in a current video frame;
performing, when the predictive coding mode is intra prediction mode, an intra prediction to obtain at least a reconstructed value of a first color component for a pixel in the current block according to one or more reconstructed pixels in the current video frame;
fitting a mapping relationship for the first color component of the current block and a second color component of the current block according to a reference region of the current block, the reference region being selected according to two or more template regions for the current block; and
generating, according to at least the reconstructed value of the first color component for the pixel in the current block and the mapping relationship, a predicted value of the second color component for the pixel in the current block.

2. The video decoding method according to claim 1, wherein the fitting the mapping relationship comprises:
acquiring at least an initial prediction model from a plurality of candidate models;
acquiring first reconstructed values of the first color component and second reconstructed values of the second color component for pixels in the reference region; and
performing parameter fitting on at least the initial prediction model according to the first reconstructed values of the first color component and the second reconstructed values of the second color component for the pixels to obtain a target prediction model, the target prediction model indicating the mapping relationship.

3. The video decoding method according to claim 2, wherein the video decoding method further comprises:
acquiring availability information of one or more sub-regions constituting the reference region; and
adjusting the reference region according to the availability information of the one or more sub-regions.

4. The video decoding method according to claim 3, wherein the adjusting the reference region comprises:
removing a sub-region having an unavailable state from the reference region; and
configuring, when all sub-regions in the reference region have the unavailable state, the reference region to have the unavailable state.

5. The video decoding method according to claim 2, wherein the performing the parameter fitting comprises:
acquiring a reference region sampling mode of the current block, the reference region sampling mode comprising one of full-pixel sampling or partial-pixel sampling;
determining, when the reference region sampling mode of the current block is the full-pixel sampling, all pixels in the reference region as sample pixels;
determining, when the reference region sampling mode of the current block is the partial-pixel sampling, sample pixels having specified sampling positions in the reference region; and
performing the parameter fitting on the initial prediction model according to the first reconstructed values of the first color component and the second reconstructed values of the second color component for the sample pixels to obtain the target prediction model.

6. The video decoding method according to claim 5, wherein the specified sampling positions comprise at least one of:
a specified sampling position with position coordinates satisfying a preset coordinate value condition;
a specified sampling position that is selected along a preset pixel scanning direction; and
a specified sampling position with a reconstructed value of the first color component being within a preset value range.

7. The video decoding method according to claim 6, wherein the preset coordinate value condition comprises:
at least one of a horizontal position coordinate or a vertical position coordinate of the position coordinates being even; or
at least one of the horizontal position coordinate or the vertical position coordinate being odd.

8. The video decoding method according to claim 2, wherein the initial prediction model is configured to generate an output value that is the second color component for a specified pixel based on a first input value that is the first color component for the specified pixel and at least a second input value that is the first color component for a neighboring pixel, and the neighboring pixel is a nearest-neighbor or next-nearest-neighbor pixel of the specified pixel.

9. The video decoding method according to claim 2, wherein the initial prediction model comprises a combination of one or more terms with respective weighting parameters, and the combination of the one or more terms is calculated based on input values that are the first color component of at least two pixels.

10. The video decoding method according to claim 9, wherein the initial prediction model comprises a combination of at least two terms with different orders, and an order of a term is a highest power of an input in the term.

11. The video decoding method according to claim 1, wherein the reference region comprises one or more nearest-neighbor regions or one or more next-nearest-neighbor regions; and the one or more nearest-neighbor regions comprise a first image region having a first specific image size and being at an upper side or a left side of the current block, and the one or more next-nearest-neighbor regions comprise a second image region having a second specific image size and being at an upper left, a lower left, or an upper right of the current block.

12. The video decoding method according to claim 11, wherein the one or more next-nearest-neighbor regions comprise at least one of:
a first next-nearest-neighbor region that is located at the upper right of the current block and has a same horizontal image size as the current block in a horizontal direction and has a specified vertical image size in a vertical direction, and the specified vertical image size is greater than or equal to one;
a second next-nearest-neighbor region that is located at the lower left of the current block and has a same vertical image size as the current block in the vertical direction and has a specified horizontal image size in the horizontal direction; and
a third next-nearest-neighbor region that is located at the upper left of the current block and has a specified horizontal image size in the horizontal direction and has a specified vertical image size in the vertical direction.

13. The video decoding method according to claim 1, wherein the reference region comprises at least one of a full-region combination, a left-region combination, or an upper-region combination;
the full-region combination comprises a first nearest-neighbor region located at a left side of the current block, a second nearest-neighbor region located at an upper side of the current block, a first next-nearest-neighbor region located at an upper right of the current block, a second next-nearest-neighbor region located at a lower left of the current block, and a third next-nearest-neighbor region located at an upper left of the current block;
the left-region combination comprises the first nearest-neighbor region located at the left side of the current block and the second next-nearest-neighbor region located at the lower left of the current block; and
the upper-region combination comprises the second nearest-neighbor region located at the upper side of the current block, and the first next-nearest-neighbor region located at the upper right of the current block.

14. The video decoding method according to claim 1, wherein the generating comprises:
acquiring a color component prediction condition of the current block, the color component prediction condition indicating whether to predict according to a cross color component prediction; and
generating, when the current block satisfies the color component prediction condition, and according to the reconstructed value of the first color component for the pixel, the predicted value of the second color component for the pixel.

15. The video decoding method according to claim 14, wherein the color component prediction condition comprises at least one of:
an index of the current block has a specified index value;
image features of the current block satisfy a preset feature condition; and
image features of the reference region satisfy the preset feature condition.

16. The video decoding method according to claim 15, wherein the image features of the current block satisfy at least one of:
an image size of the current block being within a specified size range; or
a position of the current block being within a specified region range.

17. The video decoding method according to claim 15, wherein the image features of the reference region satisfy at least one of:
a region area of the reference region being greater than a specified area threshold; or
a quantity of specified sampling positions in the reference region being greater than a quantity of model parameters of a prediction model, the prediction model indicating the mapping relationship between the first color component and the second color component.

18. The video decoding method according to claim 1, wherein the video decoding method further comprises:
determining a sampling window having a specified window size according to a pixel position of the pixel; and
downsampling reconstructed values of the first color component for pixels in the sampling window to obtain the reconstructed value of the first color component for the pixel at the pixel position.

19. A video encoding method, comprising:
determining a predictive coding mode of a current block in a current video frame;
performing, when the predictive coding mode is intra prediction mode, an intra prediction to obtain at least a reconstructed value of a first color component for a pixel in the current block according to one or more reconstructed pixels in the current video frame;
fitting a mapping relationship for the first color component of the current block and a second color component of the current block according to a reference region of the current block, the reference region being selected according to two or more template regions for the current block;
generating, according to at least the reconstructed value of the first color component for the pixel in the current block and the mapping relationship, a predicted value of the second color component for the pixel in the current block; and
encoding the current block into coded information in a bitstream based on the predicted value of the second color component for the pixel in the current block.

20. A non-transitory computer-readable storage medium storing instructions which when executed by a processor cause the processor to perform a method of encoding a bitstream, the encoding method comprising:
determining a predictive coding mode of a current block in a current video frame;
performing, when the predictive coding mode is intra prediction, an intra prediction to obtain at least a reconstructed value of a first color component for a pixel in the current block according to one or more reconstructed pixels in the current video frame;
fitting a mapping relationship for the first color component of the current block and a second color component of the current block according to a reference region of the current block, the reference region being selected according to two or more template regions for the current block;
generating, according to at least the reconstructed value of the first color component for the pixel in the current block and the mapping relationship, a predicted value of the second color component for the pixel in the current block;
encoding the current block into coded information in the bitstream based on the predicted value of the second color component for the pixel in the current block; and
transmitting the bitstream.
